(19) United States
(12) Patent Application Publication
(10) Pub. No.: US 2015/0277570 A1
(43) Pub. Date: Oct. 1, 2015

(54) Providing Onscreen Visualizations of Gesture Movements

(71) Applicant: Google Inc., Mountain View, CA (US)

(72) Inventors: Alejandro Jose Kauffmann, San Francisco, CA (US); Christian Plagemann, Palo Alto, CA (US)

(73) Assignee: Google Inc., Mountain View, CA (US)

(21) Appl. No.: 14/230,194

(22) Filed: Mar. 31, 2014

(51) Int. Cl. G06F 3/01

(52) U.S. Cl. CPC G06F 3/017

(57) ABSTRACT

Described is a technique for providing onscreen visualizations of three-dimensional gestures. A display screen may display a gesture indicator that provides an indication of when a gesture begins to produce an effect and when the gesture is complete. The gesture indicator may also indicate a user's relative hand position within a single axis of a capture device's field-of-view. Once the visual indicator is positioned, the characteristics of the indicator may be altered to indicate a direction of movement along one or more dimensions. The direction of movement may be provided using a direction of movement effect. Accordingly, the visualization of a gesture may be enhanced by limiting the visualization to expressive motion along a single axis.

### BACKGROUND

Touchless or in-air gestural interfaces often rely on mouse and touch-based input conventions, and thus treat a user's hand as an input pointer. Accordingly, these in-air gesture interfaces often adopt visual metaphors developed for pointer-based system. The physical analogues of these metaphors, however, are often ill-suited for three-dimensional gesture interfaces. For example, when using in-air gestures in conjunction with a display screen, a dimensional disparity often exists between the unhindered three-dimensional movement in space of the user's hand and the two-dimensional output of a display screen. Accordingly, visual feedback of gesture movements is often limited to a two-dimensional framework and thus may ignore the continuous and temporal nature of three-dimensional gestures.

### BRIEF SUMMARY

In an implementation, described is a method of providing a visualization of a gesture captured by a capture device. The method may include receiving, by a computing device, an indication of a first hand gesture of a user, the first hand gesture moving substantially along a first axis of a field-of-view of a capture device operatively coupled to the computing device and outputting, on a display operatively coupled to the computing device, a gesture indicator based on the first hand gesture. The method may include receiving, by the computing device, an indication of a second hand gesture of the user and altering a characteristic of the outputted gesture indicator based on the second hand gesture, the altered characteristic indicating a component of movement of the second hand gesture substantially along only a second axis of the field-of-view. The first axis and the second axis may each include an X-axis, a Y-axis, or a Z-axis. The first gesture and the second gesture may include various hand movements. For example, the movements may include a raise hand movement, a swipe hand movement, or a push hand movement. The altered characteristic may include providing a direction of movement effect and the direction of movement effect may alter the characteristics of the provided gesture indicator beyond repositioning the gesture indicator.

In an implementation, described is a method of providing a visualization of a gesture captured by a capture device. The method may include receiving, by a computing device, an indication of a first hand gesture comprising a raise-hand movement and outputting, on a display operatively coupled to the computing device, a gesture indicator based on the first hand gesture. The method may also include determining a relative position of the first hand gesture along a first axis of a field-of-view of a capture device operatively coupled to the computing device and positioning the outputted gesture indicator based on the determined relative position. In addition, the method may include receiving, by the computing device, an indication of a second hand gesture of the user and altering a characteristic of the outputted gesture indicator based on the second hand gesture, the altered characteristic indicating a component of movement of the second hand gesture substantially along only a second axis of the field-of-view. The first axis and the second axis may each include an X-axis, a Y-axis, or a Z-axis. The first gesture and the second gesture may include various hand movements. For example, the movements may include a raise hand movement, a swipe hand movement, or a push hand movement. The altered characteristic may include providing a direction of movement effect and the direction of movement effect may alter the characteristics of the provided gesture indicator beyond repositioning the gesture indicator.

In an implementation, described is a device for providing a visualization of a gesture captured by a capture device. The device may include a processor, and the processor may be configured to receive an indication of a first hand gesture of a user and output, on a display operatively coupled to the processor, a gesture indicator based on the first hand gesture. The processor may also be configured to receive an indication of a second hand gesture of the user and alter a characteristic of the outputted gesture indicator based on the second hand gesture, the altered characteristic indicating a component of movement of the second hand gesture substantially along only a first axis of a field-of-view of the capture device. The first and second hand gestures may include a various hand movements. For example, the movements may include a raise hand movement, a swipe hand movement, or a push hand movement. The altered characteristic may include providing a direction of movement effect and/or repositioning the gesture indicator.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a functional block diagram of a representative device according to an implementation of the disclosed subject matter.

FIG. 2 shows an example arrangement of a device capturing gesture input for a display screen according to an implementation of the disclosed subject matter.

FIG. 3 shows an example of displaying a gesture indicator at a relative position within a field-of-view of the capture device according to an implementation of the disclosed subject matter.

FIG. 4 shows a flow diagram of providing a visualization of a gesture according to an implementation of the disclosed subject matter.

FIG. 5A shows an example gesture indicator for visualizing a gesture along an X-axis according to an implementation of the disclosed subject matter.

FIG. 5B shows the gesture indicator of FIG. 5A with an example of altered characteristics indicating a movement along an X-axis according to an implementation of the disclosed subject matter.

FIG. 6A shows an example gesture indicator for visualizing a gesture along a Z-axis according to an implementation of the disclosed subject matter.

FIG. 6B shows the gesture indicator of FIG. 6A with an example of altered characteristics indicating a movement along a Z-axis according to an implementation of the disclosed subject matter.

### DETAILED DESCRIPTION

Described are techniques for providing onscreen visualizations for in-air gesture movements by providing a visual referent for a three-dimensional gesture. A computing device that is operatively coupled to a capture device may output on a display an indication that a gesture movement has been recognized, that an action has been taken responsive to the recognized gesture, and/or that the recognized gesture has completed. The indication may also indicate a user's relative hand position within a single axis of a capture device's field-of-view. For example, if the user's hand is at a relatively right-of-center position within the camera's field-of-view, an indicator may be positioned at a right-of-center position within the display screen. In addition, the computing device may alter characteristics of the indicator to indicate a direction of movement of a gesture. For example, the indicator may provide a visualization of a component of movement along a single axis of the field-of-view. Accordingly, the techniques described herein may enhance the visualization of three-dimensional gestures by limiting the visualization of a gesture movement to a single axis.

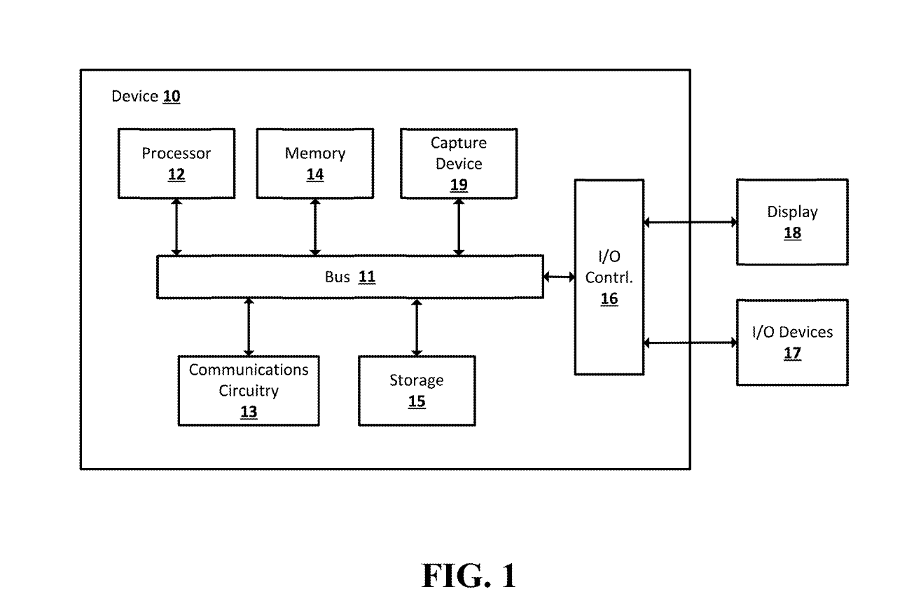

FIG. 1 shows a functional block diagram of a representative device according to an implementation of the disclosed subject matter. The device 10 may include a bus 11, processor 12, memory 14, I/O controller 16, communications circuitry 13, storage 15, and a capture device 19. The device 10 may also include or may be coupled to a display 18 and one or more I/O devices 17.

The device 10 may include or be part of a variety of types of devices, such as a set-top box, television, media player, mobile phone (including a “smartphone”), computer, or other type of device. The processor 12 may be any suitable programmable control device and may control the operation of one or more processes, such as gesture recognition as discussed herein, as well as other processes performed by the device 10. As described herein, actions may be performed by a computing device, which may refer to a device (e.g. device 10) and/or one or more processors (e.g. processor 12). The bus 11 may provide a data transfer path for transferring between components of the device 10.

The memory 14 may include one or more different types of memory which may be accessed by the processor 12 to perform device functions. For example, the memory 14 may include any suitable non-volatile memory such as read-only memory (ROM), electrically erasable programmable read only memory (EEPROM), flash memory, and the like, and any suitable volatile memory including various types of random access memory (RAM) and the like.

The communications circuitry 13 may include circuitry for wired or wireless communications for short-range and/or long range communication. For example, the wireless communication circuitry may include Wi-Fi enabling circuitry for one of the 802.11 standards, and circuitry for other wireless network protocols including Bluetooth, the Global System for Mobile Communications (GSM), and code division multiple access (CDMA) based wireless protocols. Communications circuitry 13 may also include circuitry that enables the device 10 to be electrically coupled to another device (e.g. a computer or an accessory device) and communicate with that other device. For example, a user input component such as a wearable device may communicate with the device 10 through the communication circuitry 13 using a short-range communication technique such as infrared (IR) or other suitable technique.

The storage 15 may store software (e.g., for implementing various functions on device 10), and any other suitable data. The storage 15 may include a storage medium including various forms volatile and non-volatile memory. Typically, the storage 15 includes a form of non-volatile memory such as a hard-drive, solid state drive, flash drive, and the like. The storage 15 may be integral with the device 10 or may be separate and accessed through an interface to receive a memory card, USB drive, optical disk, a magnetic storage medium, and the like.

An I/O controller 16 may allow connectivity to a display 18 and one or more I/O devices 17. The I/O controller 16 may include hardware and/or software for managing and processing various types of I/O devices 17. The I/O devices 17 may include various types of devices allowing a user to interact with the device 10. For example, the I/O devices 17 may include various input components such as a keyboard/keypad, controller (e.g. game controller, remote, etc.) including a smartphone that may act as a controller, a microphone, and other suitable components. The I/O devices 17 may also include components for aiding in the detection of gestures including wearable components such as a watch, ring, or other components that may be used to track body movements (e.g. holding a smartphone to detect movements).

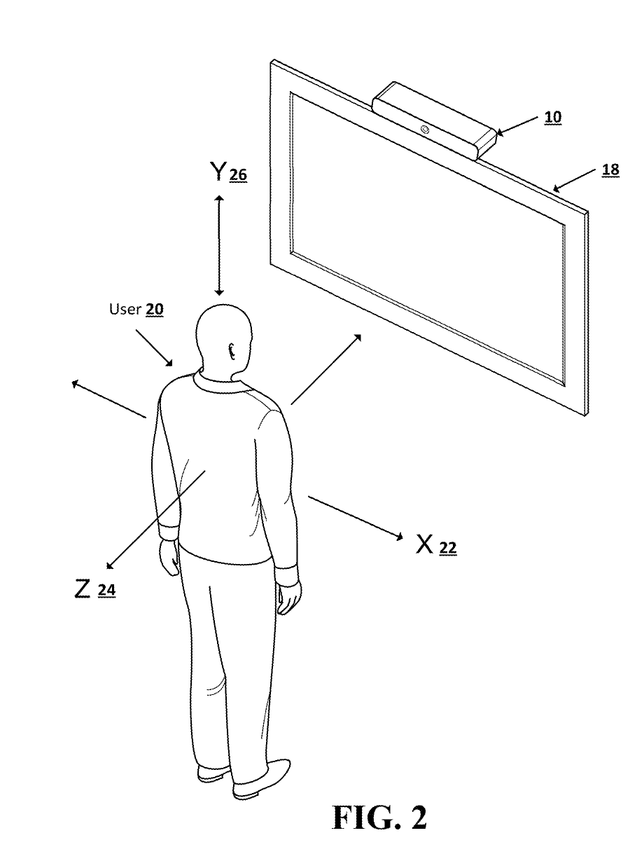

The device 10 may act a standalone unit that is coupled to a separate display 18 (as shown in FIGS. 1 and 2), or the device 10 may be integrated with or be part of a display 18 (e.g. integrated into a television unit). When acting as standalone unit, the device 10 may be coupled to a display 18 through a suitable data connection such as an HDMI connection, a network type connection, or a wireless connection. The display 18 may be any a suitable component for providing visual output as a display screen such as a television, computer screen, projector, and the like.

The device 10 may include a capture device 19 (as shown in FIGS. 1 and 2). Alternatively, the device 10 may be coupled to the capture device 19 through the I/O controller 16 in a similar manner as described with respect to a display 18. For example, the device 10 may include a remote device (e.g. server) that receives data from a capture device 19 (e.g. webcam or similar component) that is local to the user. The capture device 19 enables the device 10 to capture still images, video, or both. The capture device 19 may include one or more cameras for capturing an image or series of images continuously, periodically, at select times, and/or under select conditions. The capture device 19 may be used to visually monitor one or more users such that gestures and/or movements performed by the one or more users may be captured, analyzed, and tracked to detect a gesture input as described further herein.

The capture device 19 may be configured to capture depth information including a depth image using techniques such as time-of-flight, structured light, stereo image, or other suitable techniques. The depth image may include a two-dimensional pixel area of the captured image where each pixel in the two-dimensional area may represent a depth value such as a distance. The capture device 19 may include two or more physically separated cameras that may view a scene from different angles to obtain visual stereo data to generate depth information.

Other techniques of depth imaging may also be used. The capture device 19 may also include additional components for capturing depth information of an environment such as an IR light component, a three-dimensional camera, and a visual image camera (e.g. RGB camera). For example, with time-of-flight analysis the IR light component may emit an infrared light onto the scene and may then use sensors to detect the backscattered light from the surface of one or more targets (e.g. users) in the scene using a three-dimensional camera or RGB camera. In some instances, pulsed infrared light may be used such that the time between an outgoing light pulse and a corresponding incoming light pulse may be measured and used to determine a physical distance from the capture device 19 to a particular location on a target.

FIG. 2 shows an example arrangement of a device capturing gesture movements for a display interface according to an implementation of the disclosed subject matter. A device 10 that is coupled to a display 18 may capture gesture movements from a user 20. The display 18 may include an interface that allows a user to interact with the display 18 or additional components coupled to the device 10. The interface may include menus, overlays, and other display elements that are displayed on a display screen to provide visual feedback to the user. The user 20 may interact with an interface displayed on the display 18 by performing various gestures as described further herein. Gesture detection may be based on measuring and recognizing various body movements of the user 20. Typically, the gesture may include a hand movement, but other forms of gestures may also be recognized. For example, a gesture may include movements from a user's arms, legs, feet, and other movements such as body positioning or other types of identifiable movements from a user. These identifiable movements may also include head movements including nodding, shaking, etc., as well as facial movements such as eye tracking, and/or blinking In addition, gesture detection may be based on combinations of movements described above including being coupled with voice commands and/or other parameters. For example, a gesture may be identified based on a hand movement in combination with tracking the movement of the user's eyes, or a hand movement in coordination with a voice command.

When performing gesture detection, specific gestures may be detected based on information defining a gesture, condition, or other information. For example, gestures may be recognized based on information such as a distance of movement (either absolute or relative to the size of the user), a threshold velocity of the movement, a confidence rating, and other criteria. The criteria for detecting a gesture may vary between applications and between contexts of a single application including variance over time.

Gestures may include in-air type gestures that may be performed within a three-dimensional environment. In addition, these in-air gestures may include touchless gestures that do not require inputs to a touch surface. As described, the gesture may include movements within a three-dimensional space. The three-dimensional space may be described based on a coordinate system and/or one or more axes. These axes may include defining or establishing an X-axis 22, Y-axis 24, and Z-axis 26. In an implementation, these axes may be defined based on a the typical arrangement of a user facing a capture device 19, which is aligned with the display 18 as shown in FIG. 2. The X-axis 22 may be substantially parallel to the display 18 and substantially perpendicular to the torso of the user 20. For example, left or right type movements such as a swiping motion may be substantially along the X-axis 22. The Y-axis 24 may be substantially parallel to the display 18 and substantially parallel to the torso of the user 20. For example, up and down type movements such as a raise or lower/drop motion may be substantially along the Y-axis 24. The Z-axis may be substantially perpendicular to the display 18 and substantially perpendicular to the torso of the user 20. For example, forward and back type movements such as a push or pull motion may be substantially along the Z-axis 26. Movements may be detected based on movements substantially along one or more of these axes including combinations of movements or components of a movement along a single axis depending on a particular context.

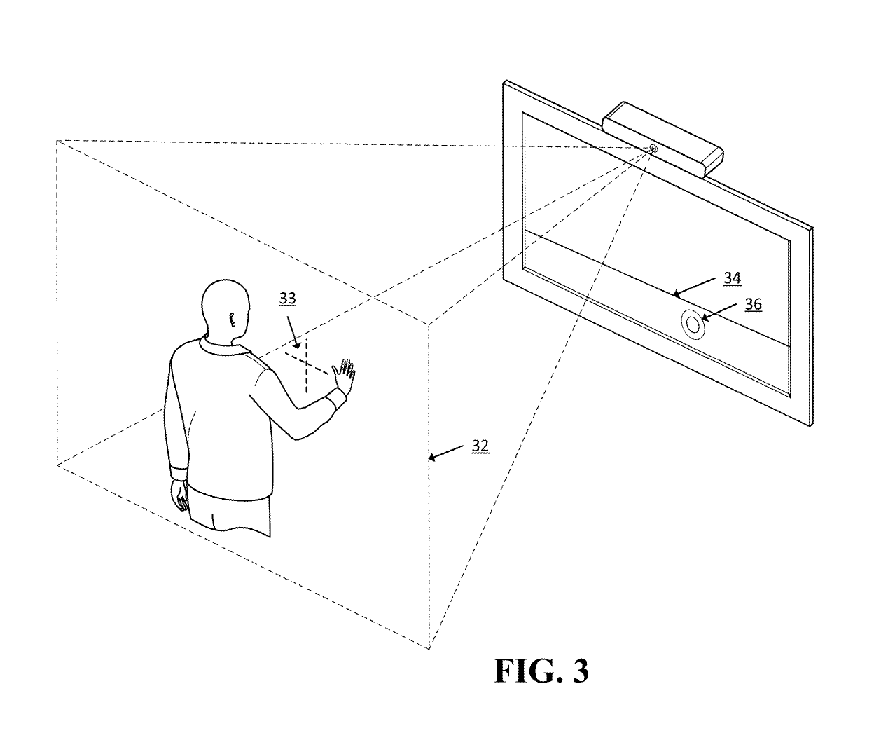

In addition to defining axes in the manner described above, the axes may be established using various other references. For example, axes may be established relative to the capture device 19 and/or display 18 (as shown in FIG. 3), relative to a user position (e.g. relative to the user's torso and/or face), relative to the alignment of two users, relative to a gesture movement, and/or other techniques. Accordingly, the device may utilize reference points on the user's body that provide a natural point of reference when performing gestures. For example, the device may select a point on a central portion of the body of a user as a reference point (e.g. origin of a coordinate system) when tracking body movements such as the center of a chest, sternum, solar plexus, center of gravity, or within regions such as the thorax, abdomen, pelvis, and the like. One or more axes may also be defined and/or established based on these reference points. For example, in an implementation, the X-axis may be defined as substantially parallel to a line connecting a left and a right shoulder of the user, the Y-axis may be defined as substantially parallel to a line connecting a head and a pelvis of the user (or parallel to a torso), and the Z-axis may be defined as substantially perpendicular to the X-axis and Y-axis. In addition, a user may perform a gesture to define an axis. For example, a user may perform a substantially up/down gesture movement and a Y-axis may be defined based on this movement. In yet another example, the device may use a hand and/or an initial movement of a hand to establish a point of origin for a coordinate system. For instance, a user may perform an open palm gesture, and in response, the device may establish a point of origin within the palm of the hand. Accordingly, a Y-axis may be defined as substantially along the established point on the palm to a point (e.g. fingertip) of the corresponding index or middle finger (the X-axis and Z-axis may then be defined based on the defined Y-axis).

As described herein, an axis may be described with reference to the user's body. It should be noted that these references may be used in descriptions provided herein, but are illustrative of the axes and may not necessarily correspond directly to techniques used by the computing device to define and/or determine an axis in a specific configuration. For example, an axis may be described as being defined by a line connecting a left shoulder and right shoulder, but the device may use other techniques such as multiple points including points on the head, pelvis, etc. Accordingly, the computing device may use different reference points to define substantially equivalent axes as described herein for gesture movements in order to distinguish between, for example, left/right, forward/back, and up/down movements as perceived by the user.

FIG. 3 shows an example of displaying a gesture indicator at a relative position within a field-of-view of the capture device according to an implementation of the disclosed subject matter. As shown, the device 10, or more specifically, the capture device 19 may capture information within a field-of-view 32. As shown, the field-of-view 32 may include dimensions along an X-axis and Y-axis to form a rectangular shape, as well as a dimension along a Z-axis (e.g. depth axis). The user may perform a gesture (e.g. raise hand gesture) and a position within the field-of-view 32 may be mapped onto the display screen. In an implementation, the display screen may include a gesture feedback section 34 and the gesture feedback section may include a gesture indicator 36. In other implementations, the gesture indicator 36 may be displayed without the use of a feedback section 34.

The gesture feedback section 34 may provide visual feedback to the user. The gesture feedback section 34 may be displayed on the screen in manner to minimally burden the display area. For example, the gesture feedback section 34 may be provided only on a portion of the screen such as a feedback bar. The feedback section may also be displayed with varying transparency. For example, the feedback section may be semi-transparent to allow the user to see the screen elements behind the section. The feedback section may also be dynamic in response to a gesture. For example, with a raise hand movement, the section may “scroll up” in a manner that corresponds to the movement and speed of the hand. Similarly, the section may “scroll down” and retreat (or disappear) from the screen when the hand is lowered or a gesture is completed. When a user performs a gesture in a substantially fluid motion, the feedback section may only be displayed for a brief period of time to indicate that a gesture has been completed. Accordingly, the gesture feedback section 34 may be displayed in an efficient manner without constantly burdening the display screen.

When providing visual feedback, the gesture indicator 36 may be positioned within the gesture feedback section 34 to correspond to a position of a gesture within the field-of-view 32. For example, as shown in FIG. 3, the field-of-view of the capture device includes a center position 33 and the raise hand gesture is performed at a right-of-center position within the X-axis of the field-of-view. Accordingly, the gesture indictor 36 may be positioned at a corresponding right-of-center position within the gesture feedback section 36. When displaying the gesture feedback section 34, the gesture indicator 36 may indicate a relative position for a single axis. For example, as shown in FIG. 3, the gesture feedback section only displays a relative position along an X-axis. Accordingly, the positioning may disregard a relative position along a Y-axis and Z-axis. In other implementations, the feedback information may include a relative position along a Y-axis or Z-axis. By limiting feedback information to a single axis, the gesture detection may more accurately detect particular movements and/or anticipate movements along a single axis.

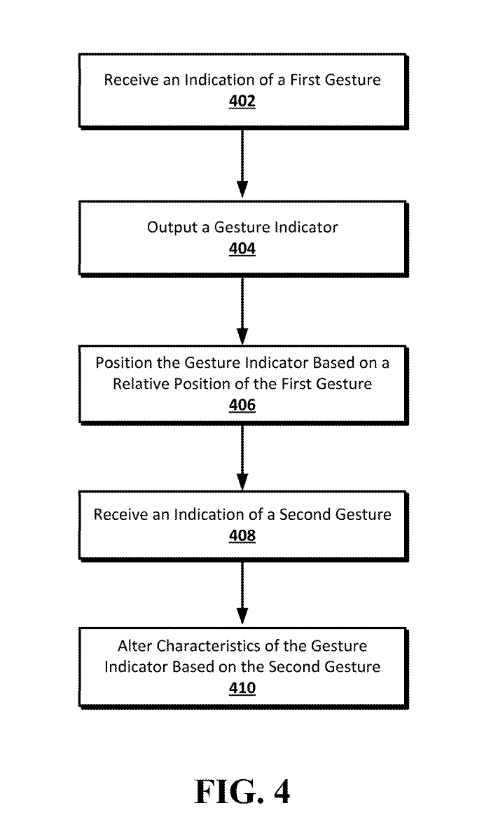

FIG. 4 shows a flow diagram of providing a visualization of a gesture according to an implementation of the disclosed subject matter. In 402, a computing device (e.g. device 10 and/or processor 12) may receive an indication of a first gesture. For example, a computing device may detect a raise hand movement based on information received from the capture device. The raise hand movement, for example, may comprise a motion of a hand moving from a lower portion of the user's 20 body to an upper portion of the body (e.g. shoulder height). In 404, the computing device may output gesture feedback information. For example, the computing device may output a gesture indicator 36 to a display (e.g. display 18).

In 406, a computing device may position the gesture indicator 36 based on a relative position and/or movement of the first gesture. For example, if a raise hand gesture is performed at a right-of-center position, the gesture indicator 36 may positioned accordingly on the display screen (e.g. positioned to relatively right-of-center position). Thus, the visual indicator may indicate to a user the relative position of the user's hand within the field-of-view of the capture device 19. Thus, the user 20 may adjust a hand position in order to provide more accurate gesture detection. The gesture indicator 36 may provide gesture feedback information only when at least a partial gesture and/or movement has been detected. Accordingly, feedback information does not burden the display screen. In contrast, traditional gesture interfaces are often designed to constantly display an object or cursor that tracks a position of a user's hand, and thus, unnecessarily clutter the display screen.

In 408, a computing device may receive an indication of a second gesture. The second gesture may include a gesture to provide an input to the device 10. For example, in the context of a media player application, the second gesture may provide an input command such as a play/pause, next, or fast forward command. In 410, the computing device may alter a characteristic of the indicator in response to the second gesture. The altered characteristic may provide an indication of that the gesture has been recognized, that an action has been taken responsive to the recognized gesture, and/or that the recognized gesture has completed. In addition, the gesture indicator 36 may provide an indication of a direction of movement of the gesture. For example, the characteristics of the gesture indicator 36 may be altered to provide a direction of movement effect. In addition, the direction of movement effect may alter the characteristics of the gesture indicator beyond merely repositioning the gesture indicator. For example, the direction of movement effect may include alterations to the gesture indicator 36 including brightness, scale, color, stroke, fill, perspective, rotation, layout, blurs, motions, and other visual effects to indicate a directional movement. In addition, other techniques may also be used such as streaks, fading, lights, smoke, particles, shadows, hand outlines, avatars, or even text representing detected hands, and other suitable techniques.

As described, the gesture indicator 36 provides information on when the gesture begins to take effect and may be displayed only upon detecting a first gesture movement (e.g. an initiation gesture). This is in contrast to traditional interfaces that constantly display an object that tracks the position of the hand. Moreover, the visualization may provide feedback for only one axis of motion with gestures being represented as progress along the axis. Such an approach is most effective when gestures produce an action not specifically tied to an onscreen element (e.g. cursor), but rather provide an action to the system as a whole.

When detecting gestures, the device may define one or more axes in a three-dimensional space relative to a position of the user. As described above, the axes may be determined based on reference points on the user. For example, the origin may correspond to a reference point that may or may not be used to define one or more axes. In one example, the origin may correspond to a reference point on a torso of the user. In another example, the origin may correspond to a reference point on the first hand of the user. In addition, the device may establish a point of origin based on an initial gesture. For example, the device may establish an origin within a palm of the first hand as a result of the user performing a gesture by the first hand with a substantially open palm. Accordingly, the device may determine subsequent gesture movements relative to the initial gesture.

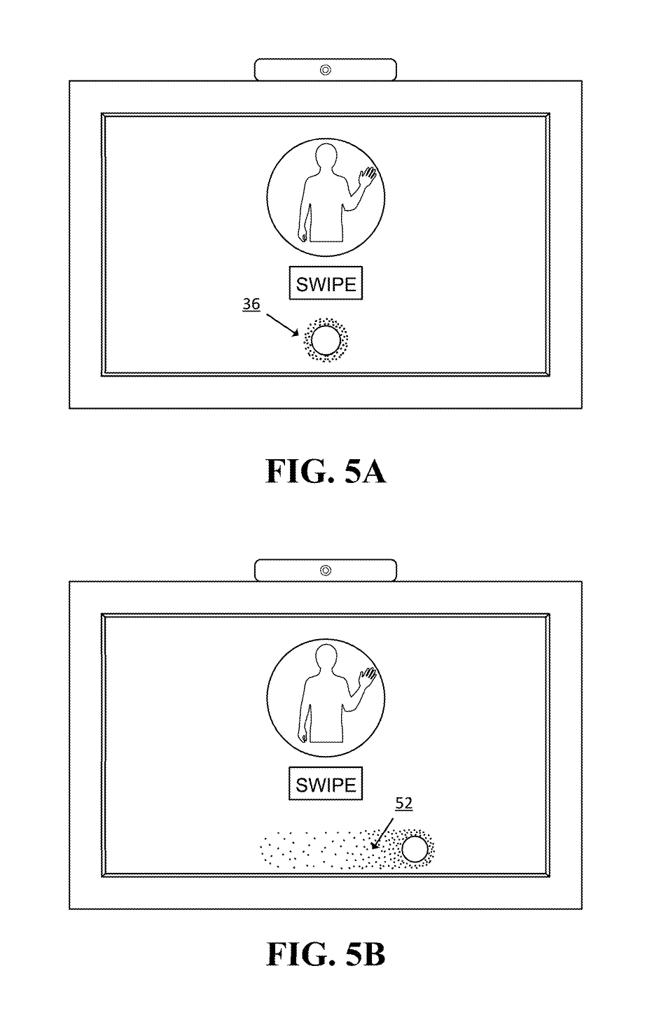

FIG. 5A shows an example gesture indicator for visualizing a gesture along an X-axis according to an implementation of the disclosed subject matter. As shown, the gesture indicator 36 may include an initial position that corresponds to a position of the user's hand along an X-axis. In this case, the user's hand may be located at a center position, and accordingly, as shown the gesture indicator 36 may be positioned within the center of the feedback section. FIG. 5B shows the gesture indicator of FIG. 5A with an example of altered characteristics indicating a movement along an X-axis according to an implementation of the disclosed subject matter. The gesture indicator 36 may include a direction of movement effect for a swipe gesture. As shown, the user may perform a horizontal swipe movement and the gesture indicator 36 may be altered to provide a streak effect 52 to identify that the swipe gesture has begun to take effect.

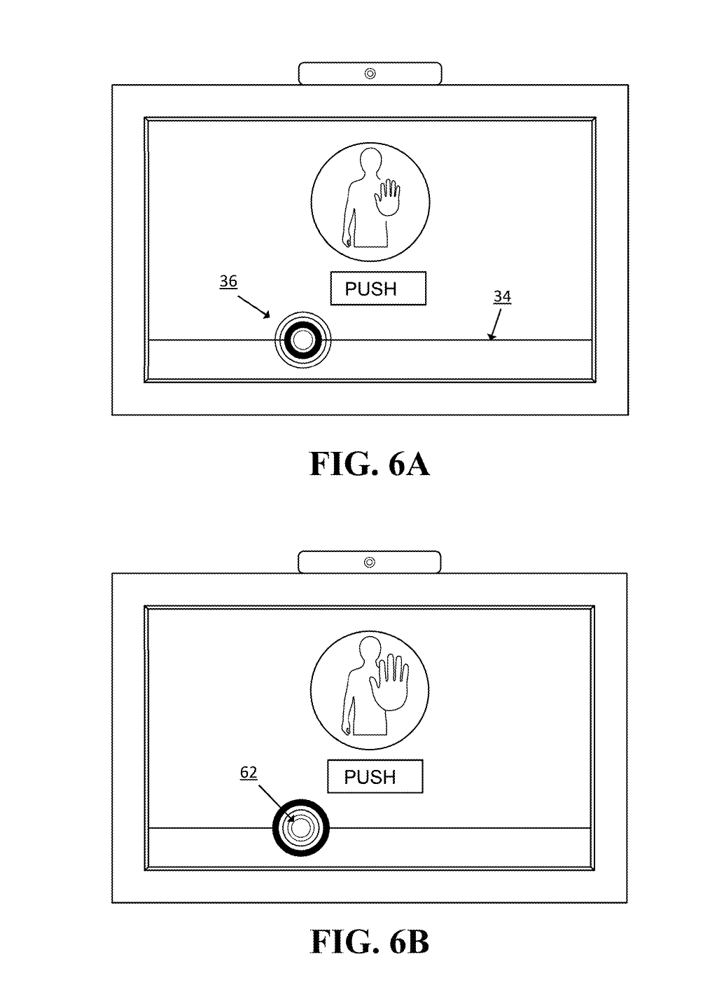

FIG. 6A shows an example gesture indicator for visualizing a gesture along a Z-axis according to an implementation of the disclosed subject matter. In FIG. 6A, a gesture feedback section 34 may include a gesture indicator 36 and the gesture indicator 36 may be positioned at a location that corresponds to a position of the user's hand along an X-axis. In this case, the user's hand may be located in a left-of-center position, and accordingly, as shown the gesture indicator 36 may be positioned within a left-of-center position of the gesture feedback section 34. FIG. 6B shows the gesture indicator of FIG. 6A with an example of altered characteristics indicating a movement along a Z-axis according to an implementation of the disclosed subject matter. The gesture indicator 36 may include a direction of movement effect for a push gesture. The push gesture may include the user moving a hand closer to the display screen and the gesture indicator 36 may be altered to provide a push effect 62. In this example, successive rings around of the gesture indicator 36 may become opaque to indicate that the gesture has been recognized. In addition, the gesture indicator 36 or gesture feedback section 34 may include an indication of when the gesture is completed. In this case, the gesture is completed when the outermost of the successive rings become opaque as shown.

As shown in the examples of FIGS. 5 and 6, the gesture indicator 36 may provide a visualization for the continuous nature (e.g. initiation, performance, and completion) of three-dimensional gestures. The gesture indicator 36 may “appear” or provide an initial movement to provide an indication of an initiated movement. The gesture indicator 36 may also provide a direction of movement effect, as shown in the example above, to provide an indication that the gesture is being performed. In addition, the gesture indicator 36 may provide an indication of when the gesture is complete (e.g. the gesture provides an input). It should be noted that the gesture indicators and direction of movement effects in FIGS. 5 and 6 are merely examples and that other suitable techniques may also be employed.

Various implementations may include or be embodied in the form of computer-implemented process and an apparatus for practicing that process. Implementations may also be embodied in the form of a computer-readable storage containing instructions embodied in non-transitory and/or tangible memory and/or storage, wherein, when the instructions are loaded into and executed by a computer (or processor), the computer becomes an apparatus for practicing implementations of the disclosed subject matter.

The flow diagrams described herein are included as examples. There may be variations to these diagrams or the steps (or operations) described therein without departing from the implementations described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

References to “one implementation,” “an implementation,” “an example implementation,” and the like, indicate that the implementation described may include a particular feature, but every implementation may not necessarily include the feature. Moreover, such phrases are not necessarily referring to the same implementation. Further, when a particular feature is described in connection with an implementation, such feature may be included in other implementations whether or not explicitly described. The term “substantially” may be used herein in association with a claim recitation and may be interpreted as “as nearly as practicable,” “within technical limitations,” and the like.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
receiving, by a computing device, an indication of a first hand gesture of a user, the first hand gesture moving substantially along a first axis of a field-of-view of a capture device operatively coupled to the computing device;
outputting, on a display operatively coupled to the computing device, a gesture indicator based on the first hand gesture;
receiving, by the computing device, an indication of a second hand gesture of the user; and
altering a characteristic of the outputted gesture indicator based on the second hand gesture, the altered characteristic indicating a component of movement of the second hand gesture substantially along only a second axis of the field-of-view.

2. The method of claim 1, wherein the first axis comprises a Y-axis and the second axis comprises an X-axis.

3. The method of claim 2, wherein the Y-axis is substantially parallel to the display and substantially parallel to a torso of the user.

4. The method of claim 3, wherein the X-axis is substantially parallel to the display and substantially perpendicular to the torso of the user.

5. The method of claim 1, wherein the first axis comprises a Y-axis and the second axis comprises a Z-axis.

6. The method of claim 5, wherein the Y-axis is substantially parallel to the display and substantially parallel to a torso of the user, and wherein the Z-axis is substantially perpendicular to the display and substantially perpendicular to the torso of the user.

7. The method of claim 2, wherein the Y-axis is substantially parallel to a line connecting a head and a pelvis of the user.

8. The method of claim 7, wherein the X-axis is substantially parallel to a line connecting a left and a right shoulder of the user.

9. The method of claim 5, wherein the Y-axis is substantially parallel to a line connecting a head and a pelvis of the user, and the Z-axis is substantially perpendicular to the Y-axis.

10. The method of claim 2, wherein the first hand gesture comprises a raise-hand movement.

11. The method of claim 2, wherein the second hand gesture comprises a swipe-hand movement.

12. The method of claim 5, wherein the second hand gesture comprises a push-hand movement.

13. The method of claim 1, wherein said altering the characteristic of the outputted gesture indicator includes providing a direction of movement effect.

14. The method of claim 13, wherein the direction of movement effect alters the characteristic of the outputted gesture indicator beyond repositioning the gesture indicator.

15. A method, comprising:
receiving, by a computing device, an indication of a first hand gesture comprising a raise-hand movement;
outputting, on a display operatively coupled to the computing device, a gesture indicator based on the first hand gesture;
determining a relative position of the first hand gesture along a first axis of a field-of-view of a capture device operatively coupled to the computing device;
positioning the outputted gesture indicator based on the determined relative position;
receiving, by the computing device, an indication of a second hand gesture of the user; and
altering a characteristic of the outputted gesture indicator based on the second hand gesture, the altered characteristic indicating a component of movement of the second hand gesture substantially along only a second axis of the field-of-view.

16. The method of claim 15, wherein the first axis comprises an X-axis and the second axis comprises an Y-axis.

17. The method of claim 16, wherein said positioning the gesture indicator comprises positioning the outputted gesture indicator in a fixed position along the Y-axis.

18. The method of claim 17, wherein the Y-axis is substantially parallel to the display and substantially parallel to a torso of the user, and the X-axis is substantially parallel to the display and substantially perpendicular to the torso of the user.

19. The method of claim 15, wherein the first axis comprises a Y-axis and the second axis comprises a Z-axis, and wherein the Y-axis is substantially parallel to the display and substantially parallel to a torso of the user and the Z-axis is substantially perpendicular to the Y-axis.

20. The method of claim 19, wherein the second hand gesture comprises a push-hand movement.

21. A device, comprising:
a processor, the processor configured to:
receive an indication of a first hand gesture of a user;
output, on a display operatively coupled to the processor, a gesture indicator based on the first hand gesture;
receive an indication of a second hand gesture of the user; and
alter a characteristic of the outputted gesture indicator based on the second hand gesture, the altered characteristic indicating a component of movement of the second hand gesture substantially along only a first axis of a field-of-view of the capture device.

22. The device of claim 21, wherein the first axis comprises an X-axis.

23. The device of claim 22, wherein the X-axis is substantially parallel to the display and substantially perpendicular to a torso of the user.

24. The device of claim 22, wherein the X-axis is substantially parallel to a line connecting a left and a right shoulder of the user.
